(19) United States
(12) Patent Application Publication
(10) Pub. No.: US 2011/0097183 A1
(43) Pub. Date: Apr. 28, 2011

(54) METHOD, APPARATUS, AND SYSTEM FOR TRANSPORTING A SLURRY APPARATUS

(75) Inventors: Kyle Alan Bruggencate, Fort McMurray (CA); Paul Frederick MacDOUGALL, Fort McMurray (CA)

(73) Assignee: SUNCOR ENERGY INC., Calgary (CA)

(21) Appl. No.: 12/842,965

(22) Filed: Jul. 23, 2010

(30) Foreign Application Priority Data
Jul. 24, 2009 (CA) 2673861

(51) Int. Cl. B60P 1/02

(52) U.S. Cl. 414/495; 414/812

(57) ABSTRACT

A system and method for transporting a slurry apparatus to a new operating location is disclosed. The system includes a first mobile support for coupling to a first lifting region of the slurry apparatus, the first mobile support being located adjacent to the slurry apparatus. The system also includes a second mobile support for supporting a second lifting region of the slurry apparatus, the first and second lifting regions being selected such that a center of mass of the slurry apparatus is disposed within a stability region defined between the first lifting region and the second lifting region. The first and second mobile supports are operable to take up a load of the slurry apparatus and to advance in a desired direction to cause the slurry apparatus to be moved toward the new operating location.

### FIELD OF THE INVENTION

This invention relates generally to mining and more particularly to transporting an apparatus used for processing an ore feed to a new operating location.

### BACKGROUND OF THE INVENTION

Surface mining operations are generally employed to excavate oil sand ore deposits that are found near the surface. One example of an oil sand ore deposit is the Northern Alberta tar sands, which comprise about 70-90% by weight of mineral solids including sand and clay, about 1-10% by weight of water, and a bitumen or oil film. The bitumen may be present in amounts ranging from a trace amount up to as much as 20% by weight. Consequently, since oil sands ore deposits comprise a relatively small percentage by weight of bitumen, it is generally most efficient and cost effective to commence at least initial processing of the ore as close as possible to the mine face where the ore is excavated.

In general, initial processing of oil sands ore involves receiving a sized ore feed at a slurry apparatus, where water is added to the sized ore to produce a slurry. The slurry may then be hydro-transported to a secondary processing plant located some distance away from the mine face. At the secondary processing plant, hydrocarbon products may be extracted from the slurry.

The slurry apparatus may be initially located in relatively close proximity to a mine face of an ore deposit, thus facilitating processing of an ore body within a conveniently conveyable distance from the slurry apparatus. Once the mine faces have been excavated beyond the convenient conveyable distance, the slurry apparatus may be relocated to a new operating location proximate a mine face of an as yet unexcavated portion of the ore deposit. The mining process thus involves successively excavating portions of an ore deposit surrounding the slurry apparatus, followed by a movement of the slurry apparatus to a new operating location.

There is a need in the art for improved methods, apparatus, and systems for transporting a slurry apparatus between successive operating locations.

### SUMMARY OF THE INVENTION

In accordance with one aspect of the invention there is provided a system for transporting a slurry apparatus to a new operating location, the slurry apparatus having a center of mass. The system includes a first mobile support for coupling to a first lifting region of the slurry apparatus, the first mobile support being located adjacent to the slurry apparatus. The system also includes a second mobile support for supporting a second lifting region of the slurry apparatus, the first and second lifting regions being selected such that the center of mass of the slurry apparatus is disposed within a stability region defined between the first lifting region and the second lifting region. The first and second mobile supports are operable to take up a load of the slurry apparatus and to advance in a desired direction to cause the slurry apparatus to be moved toward the new operating location.

In accordance with another aspect of the invention there is provided a method for transporting a slurry apparatus to a new operating location, the slurry apparatus having a center of mass. The method involves coupling a first lifting region of the slurry apparatus to a first mobile support located adjacent to the slurry apparatus. The method also involves supporting a second lifting region of the slurry apparatus on a second mobile support, the first and second lifting regions being selected such that the center of mass of the slurry apparatus is disposed within a stability region defined between the first lifting region and the second lifting region. The method further involves taking up a load of the slurry apparatus and advancing the first and second mobile supports in a desired direction to cause the slurry apparatus to be moved toward the new operating location.

In accordance with another aspect of the invention there is provided a system for transporting a slurry apparatus to a new operating location, the slurry apparatus having a center of mass. The system includes provisions for coupling a first lifting region of the slurry apparatus to a first mobile support located adjacent to the slurry apparatus. The system also includes provisions for supporting a second lifting region of the slurry apparatus on a second mobile support, the first and second lifting regions being selected such that the center of mass of the slurry apparatus is disposed within a stability region defined between the first lifting region and the second lifting region. The system further includes provisions for taking up a load of the slurry apparatus and provisions for advancing the first and second mobile supports in a desired direction to cause the slurry apparatus to be moved toward the new operating location.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a slurry apparatus;

FIG. 2 is a perspective view of a transport system for supporting the slurry apparatus shown in FIG. 1 during transport to a new operating location;

FIG. 3 is a side view of the transport system shown in FIG. 2;

FIG. 4 is a top view of the transport system shown in FIG. 2;

FIG. 5 is a flowchart of a process for transporting the slurry apparatus shown in FIG. 1 to a new operating location;

FIG. 6 is a top view of an alternative embodiment of a transport system for supporting the slurry apparatus shown in FIG. 1 during transport to a new operating location;

FIG. 7 is an alternative embodiment of a slurry apparatus; and

FIG. 8 is a top view of an embodiment of a transport system for supporting the slurry apparatus shown in FIG. 7 during transport to a new operating location.

### DETAILED DESCRIPTION

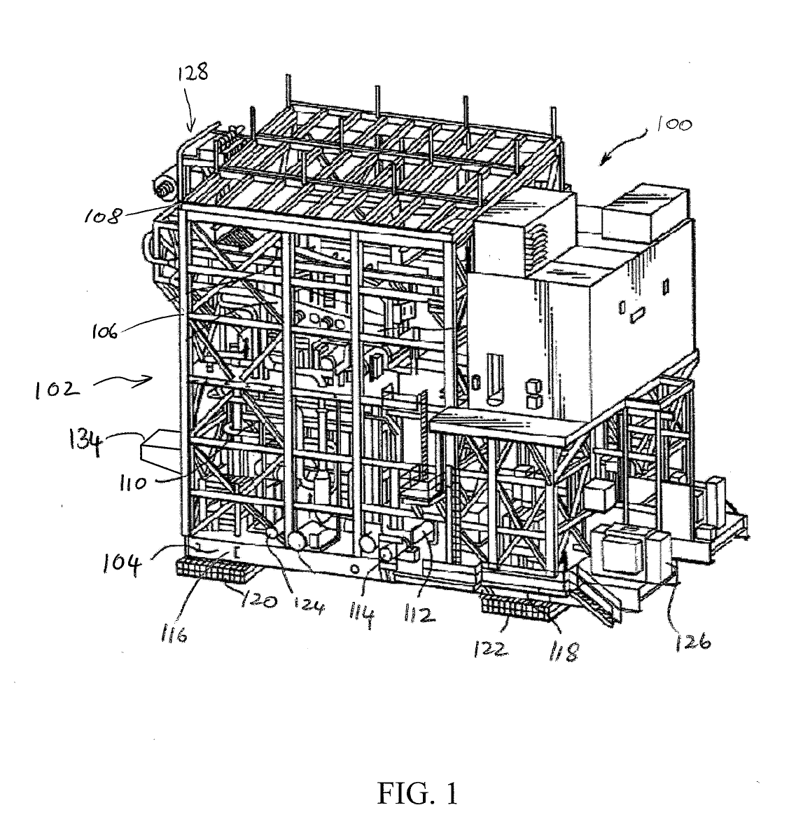

Referring to FIG. 1, a slurry apparatus for processing oil sands ore feed is shown generally at 100. The slurry apparatus 100 includes a frame 102 supported on a base 104. The frame 102 is generally constructed of structural steel beams (such as the beams 106 and 108), which may be joined by bolting or welding, for example. The slurry apparatus 100 further includes a cold water inlet 124 for receiving a water supply. Electrical power for operating the slurry apparatus 100 is coupled via a transformer 126. In the embodiment shown the slurry apparatus 100 receives an ore feed at an ore input 128. The received ore is directed into a slurry box 110. Hot water is added to the ore in the slurry box 110 to produce a slurry flow at a slurry outlet. The slurry outlet is in fluid communication with a slurry pump 112, which produces a slurry flow at a hydro-transport outlet 114. In the first embodiment, the hydro-transport outlet may be connected to a transport pipeline (not shown) for transporting the slurry to the secondary processing plant located some distance away from the slurry apparatus 100.

In the embodiment shown in FIG. 1, the base 104 includes reinforced support regions 116 and 118 for supporting the slurry apparatus 100 in an operating location. The slurry apparatus 100 also includes further reinforced support regions on an opposite side of the base 104. The slurry apparatus 100 is supported at the support regions 116 and 118 by ground engaging supports 120 and 122 (and further ground engaging supports on the opposite side of the base 104). In the embodiment shown in FIG. 1, the ground engaging supports 120 and 122 comprise crane mats.

The slurry apparatus 100 contemplated in connection with the present invention is of substantial size and weight. In one embodiment the slurry apparatus 100 has, by way of example only, dimensions of about 25 meters long by about 15 meters wide by about 15 meters tall, and has a dry weight of about 1500 metric tons. The transportation of a large slurry apparatus presents a significant challenge.

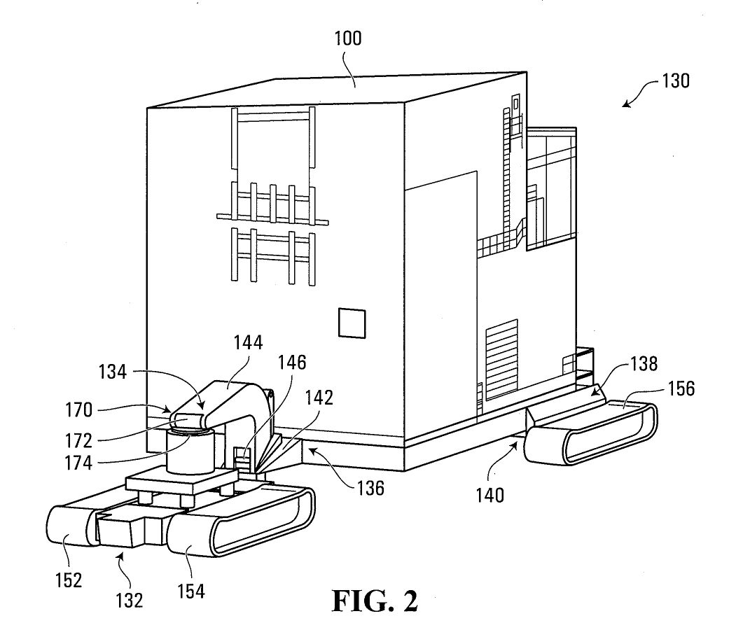

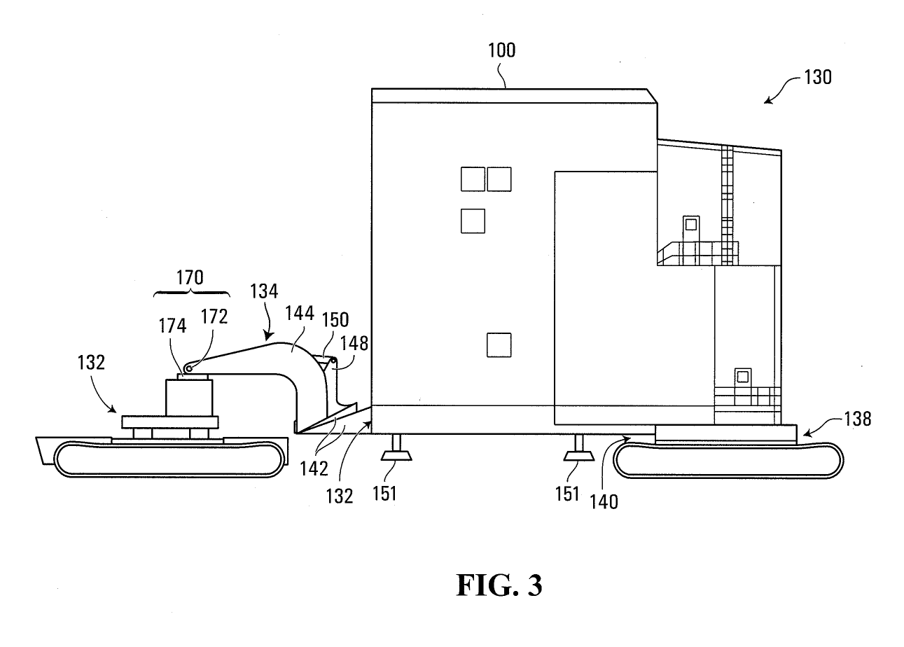

In accordance with one aspect of the present invention, a transport system for transporting the slurry apparatus 100 is shown in FIG. 2 and FIG. 3 generally at 130. Referring to FIG. 2, the transport system 130 includes a first mobile support 132 located adjacent to the slurry apparatus 100. The transport system 130 also includes a coupling arm 134 (also shown in FIG. 1) coupling a first lifting region 136 of the slurry apparatus 100 to the first mobile support 132. The transport system 130 further includes a second mobile support 138 for supporting a second lifting region 140 of the slurry apparatus 100.

In one embodiment the second mobile support 138 may comprise a crawler apparatus, having a hydraulic lifting platform (not shown) for engaging and elevating the second lifting region 140 of the slurry apparatus 100. Similarly, the first mobile support 132 may comprise a crawler adapted to couple to the coupling arm 134. Suitable crawlers are produced in various configurations by Lampson International of Kennewick Wash., USA.

The coupling arm 134 and the second mobile support 138 are operable to take up a load of the slurry apparatus 100, when the load is transferred from the stationary ground engaging supports 120 and 122 (shown in FIG. 1). The coupling arm 134 is generally sized to be able to bear the load of the first lifting region 136, and may be welded or bolted to the base 104 of the slurry apparatus 100.

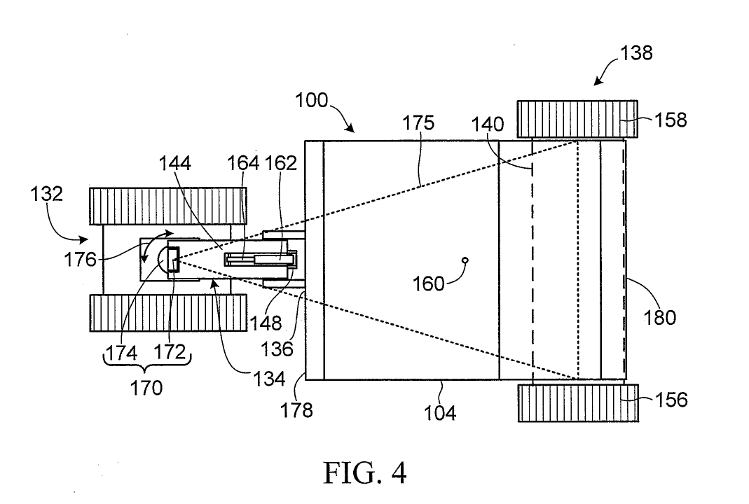

The slurry apparatus 100 and transport system 130 are shown in top view in FIG. 4. Referring to FIG. 4, in the embodiment shown the first lifting region 136 is centrally located on a first side 178 of the slurry apparatus 100 and the second lifting region 140 is peripherally located and extends generally along a second side 180 of the slurry apparatus. Referring back to FIG. 2 the coupling arm 134 is hydraulically operable and includes a first portion 142 which is securely mounted to the first lifting region 136 of the slurry apparatus 100. The coupling arm 134 further includes an articulated second portion 144 which is pivotably connected to the first portion 142 at a pivot location 146. Referring to FIG. 3, the first portion 142 of the coupling arm 134 further includes an upwardly extending portion 148. The coupling arm 134 also includes a hydraulic actuator 150 coupled between the extension 148 of the first portion 142 and the articulated second portion 144. Referring to FIG. 4, the hydraulic actuator 150 includes a cylinder 162 coupled to the extension 148 and a piston 164 connected to the articulated second portion 144.

Referring to FIGS. 3 and 4, the articulated second portion 144 of the coupling arm 134 is coupled to the first mobile support 132 using a coupling joint 170. The coupling joint 170 includes a pivot portion 172 for permitting up/down movement of the coupling arm 134 relative to the first mobile support 132. The coupling joint 170 also includes a disk portion 174 for facilitating side-to-side movement in the direction of the arrow 176 to permit the first mobile support to be steered along the transport path.

In operation, the hydraulic actuator 150 is operable to produce a force for causing the articulated second portion 144 of the coupling arm 134 to be raised or lowered with respect to the first mobile support 132. The hydraulic actuator 150 is also operable to lock the articulated second portion 144 of the coupling arm 134 in a desired transport position so that the articulated second portion 144 extends outwardly from the slurry apparatus 100 at an angle selected to cause the slurry apparatus 100 to be supported at a desired height above the ground. When the articulated second portion 144 is locked in the transport position the transport system 130 may be used to transport the slurry apparatus 100 to a new location.

Referring back to FIG. 2 in the embodiment shown the first mobile support 132 includes a first crawler track 152 and a second crawler track 154. The first mobile support 132 further includes a motive force generator (not shown). The motive force generator is coupled to the crawler tracks 152 and 154 to cause the first mobile support 132 to be advanced over the mine floor. In one embodiment the motive force generator of the first mobile support 132 is operable to provide a differential motive force to each of the first and second crawler tracks 152 and 154 for facilitating changes in direction of the first mobile support to steer the slurry facility 100 in a desired direction of transport along a path to the new operating location.

Similarly, the second mobile support 138 includes a first crawler track 156 and a second crawler track 158 (shown in FIG. 4). The second mobile support 138 also includes a motive force generator (not shown), which is coupled to the crawler tracks 156 and 158 to cause the second mobile support 132, and thus the slurry apparatus 100, to be advanced over the mine floor. Coordination of a transport rate between the first and second mobile supports 132 and 138 may be provided through either manual or automated torque control. Alternatively, torque control may be provided by configuring the first mobile support 132 as a master vehicle, and the second mobile support 138 as a slave vehicle, such that the master sets the speed and torque and the slave follows by providing the same torque and speed as the master.

In the embodiment shown in FIG. 4, a load of the first lifting region 136 bears on the first mobile support 132 and a load of the second lifting region 140 bears on the second mobile support 138, thereby defining a stability region 175 shown in broken outline. In the embodiment shown in FIG. 4, the stability region 175 has a triangular shape and extends generally between the pivot 172 and the first and second crawler tracks 156 and 158. In general stability triangles may be defined for a load in terms of three support points on an underside of the load. As long as a center of mass of the mobile load remains within the bounds of the stability triangle, the load may be considered to be safely supported.

For the slurry apparatus 100 shown in FIG. 1, the center of mass 160 is located generally at a centroid of the base 104, and is vertically displaced in an upward direction from the base 104 by a distance of about 7 meters. Accordingly, when the slurry apparatus 100 is moved along an inclined path, the center of mass 160 may be displaced either longitudinally or laterally with respect to the stability triangle 175. However, when supported as shown in FIG. 4, the stability triangle 175 is relatively large, and accordingly even relatively steep slopes may be negotiated (for example an incline of about 8%) while the center of mass 160 remains within the stability triangle. Advantageously, when supported as shown in FIG. 4, the slurry apparatus 100 is supported in a very stable condition in both longitudinal and lateral directions.

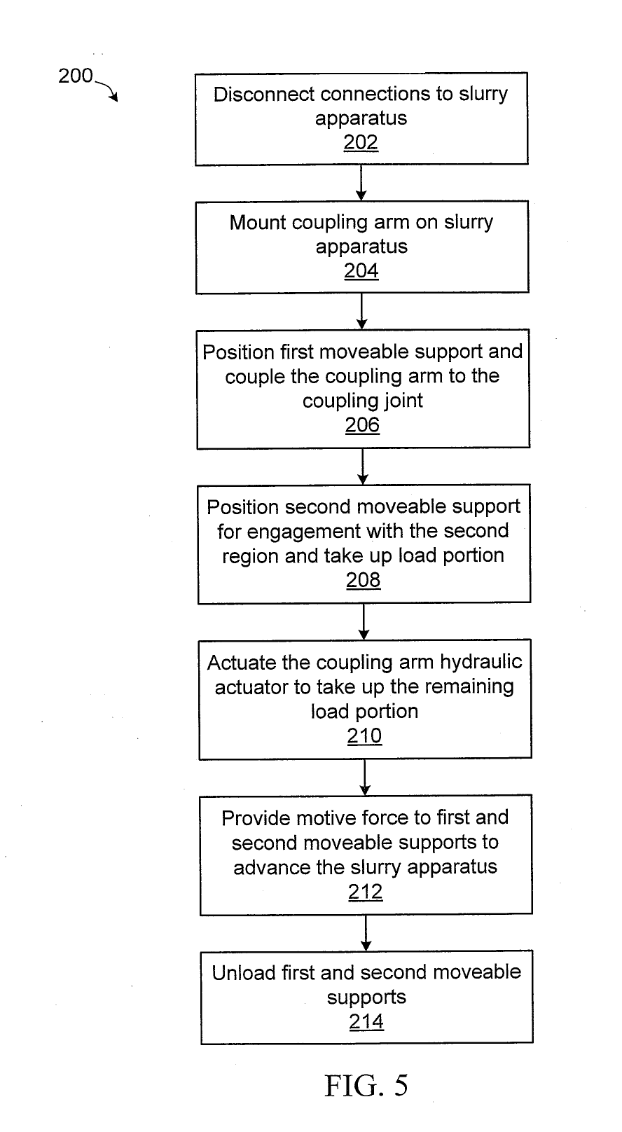

A process flowchart for transporting the slurry apparatus 100 to a new operating location is shown in FIG. 5 at 200. As shown in block 202 the process commences with the disconnection of the transformers 126 from the electrical supply, disconnection of the cold water feed from the inlet 124, and disconnection of the hydro-transport pipeline from the hydro-transport outlet 114. The ore feed (not shown) is also disconnected from the ore input 128.

At block 204 the coupling arm is then mounted to the first lifting region 136 of the slurry apparatus 100. In some embodiments the coupling arm 134 may be permanently mounted on the slurry apparatus 100 by welding, for example. In other embodiments the coupling 134 may be removably secured to the slurry apparatus 100 by a plurality of fasteners, for example.

As shown in block 206 the process then continues by moving the first mobile support 132 into position adjacent to the first lifting region 136 of the slurry apparatus 100 and coupling the coupling arm 134 to the coupling joint 170.

At block 208 the second mobile support is positioned for engagement with the first lifting region 137. Referring back to FIG. 1, in one embodiment the slurry apparatus 100 is provided with a plurality of jacks 151, which are hydraulically actuated to temporarily unload the slurry apparatus 100 from the ground engaging supports to permit removal thereof for facilitating positioning of the second mobile support 138.

As shown in block 210 the load of the slurry apparatus 100 is then transferred from the ground engaging supports 120 and 122 to the first and second mobile supports 132 and 138. In one embodiment this involves hydraulically actuating a support platform of the second mobile support 138 to be moved upwardly to engage the second lifting region 140 of the slurry apparatus 100, thus taking up a portion of the load of the slurry apparatus 100. At the same time, or shortly thereafter, the hydraulic actuator 150 is actuated to cause the coupling arm 134 to take up a remaining portion of the load of the slurry apparatus 100 bearing at the lifting region 136. At this time the slurry apparatus 100 is supported in a safe and stable condition on the first and second mobile supports 132 and 138. Advantageously, since the center of mass 160 (shown in FIG. 4) is located well within the first and second lifting regions 136 and 140, the slurry apparatus may negotiate a transport path having a grade of up to at least about 8% and a cross slope of up to at least about 5%.

As shown in block 212 the transport operation then continues by providing a motive force to the crawler tracks of the first and second mobile supports 132 and 138 to advance the slurry apparatus in a direction toward the new operating location. Advantageously the first mobile support 132 may provide a differential motive force to the first and second crawler tracks 152 and 154 to negotiate any turns that may be required along the transport path to the new operating location. Furthermore, should the transport path include inclined portions, the hydraulic actuator 150 may be actuated to raise or lower the first lifting region 136 with respect to the first mobile support 132 to maintain the slurry apparatus 100 as close as possible to a vertical orientation. Advantageously by operating the hydraulic actuator 150 in this manner, steeper incline grades may be negotiated by the slurry apparatus 100 in being transported to the new operating location.

As shown in block 214, on reaching the new operating location, the load of the slurry apparatus 100 is transferred from the first and second mobile supports 132 and 138 to ground engaging supports, such as the ground engaging supports 120 and 122 shown in FIG. 1. Once located in the new operating location the electrical, water, and hydro-transport connections may be restored. Similarly the ore feed from the mine face may be redirected to feed the ore input 128 of the slurry apparatus 100.

Advantageously, the system 130 facilitates transport of the slurry apparatus 100 in a safe and stable manner over a mine floor, thereby reducing the time to complete the move to the new location. In one embodiment the time to complete the move may be reduced substantially below 40 hours.

In another operational embodiment, the slurry apparatus 100 may be supported on the first and second mobile supports 132 and 138 during operation, thus further reducing the time necessary to complete the move, since the time associated with performing functions defined in the blocks 204 to 210, and 214 of the process 200 may be eliminated from the move time.

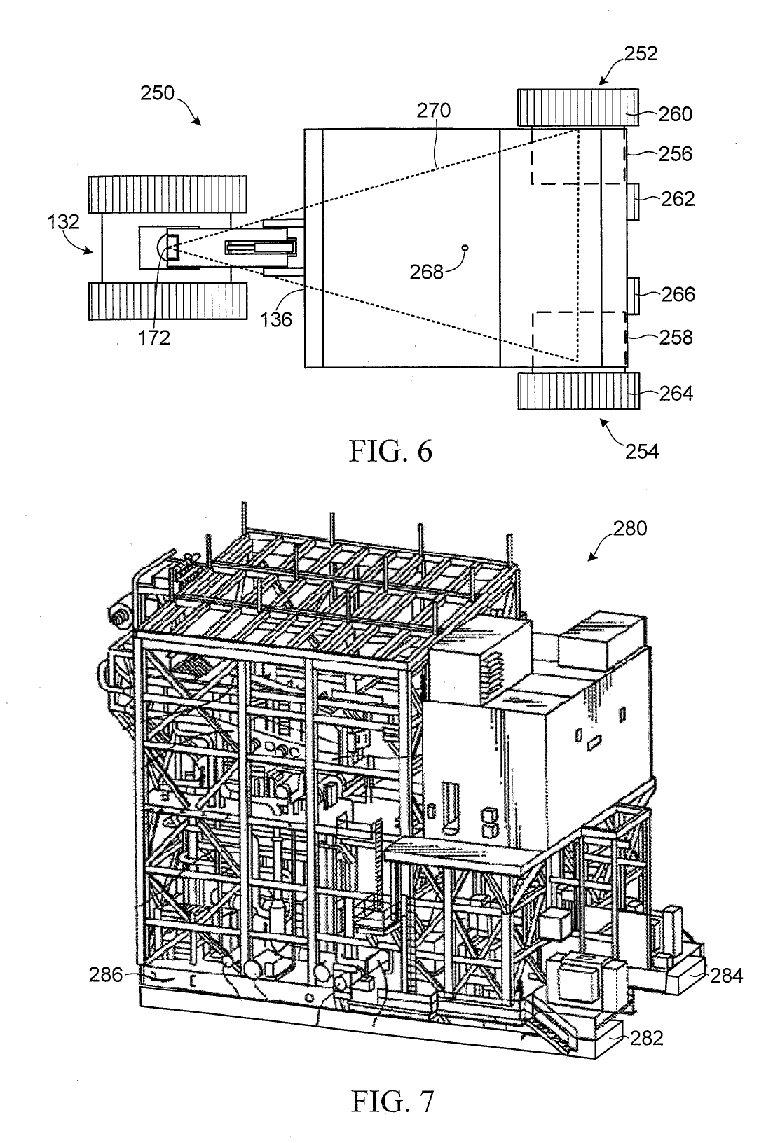

An alternative embodiment for supporting the slurry apparatus 100 is shown in FIG. 6 generally at 250. Referring to FIG. 6, in this embodiment the first mobile support 132 is configured in the same manner as described above in connection with FIG. 2 to FIG. 4. However in the support embodiment shown the second mobile support 132 shown in FIG. 4 is replaced by a pair of supports 252 and 254 supporting respective lifting regions 256 and 258. The lifting regions 256 and 258 are located at adjacent corners of the slurry apparatus 100. The mobile support 252 includes first and second crawler tracks 260 and 262 (the crawler track 262 is partially obscured by the slurry apparatus 100 in the view shown in FIG. 6). Similarly the mobile support 254 includes first and second crawler tracks 264 and 266.

In this embodiment, a stability triangle 270 is defined between the lifting region 256, the lifting region 258, and the pivot 172. The stability triangle 270 has generally similar extent and area compared to the stability triangle 175 shown in FIG. 4. A center of mass 260 of the slurry apparatus 100 is located well within the bounds of the stability triangle 270, and the slurry apparatus 100 is thus supported in a stable condition.

The mobile supports 252 and 254 may operate to transfer the load of the slurry apparatus 100 from ground engaging supports in a similar manner to that described above in connection with FIG. 5. Advantageously, by separately supporting the slurry apparatus 100 at the corner lifting regions, the load bearing on these lifting regions is supported by four sets of crawler tracks (i.e. the crawler tracks 260, 262, 264, and 266), thereby providing decreased ground bearing pressure area where the tracks engage the ground. In general, the decreased ground bearing pressure may facilitates travelling over less compacted mine surfaces than the embodiment shown in FIG. 4. Such surfaces may only require minimal grading and should not require further conditioning such as addition of aggregates or other surfacing materials.

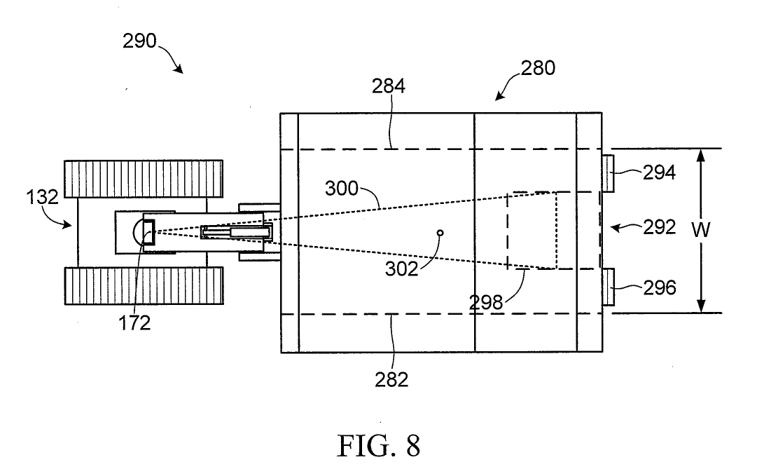

Referring to FIG. 7, an alternative embodiment of a slurry apparatus is shown generally at 280. The slurry apparatus 280 is supported on ground engaging pontoons 282 and 284, which extend along opposite sides of a base 286 of the slurry apparatus. Referring to FIG. 8, an embodiment for supporting the slurry apparatus 280 is shown generally at 290. The first mobile support 132 is again configured in the same manner as shown in FIG. 4, but in this embodiment a second mobile support 292 having a width W is provided. The width W of the second mobile support 292 permits the mobile support to be positioned between the pontoons 282 and 284 for engaging a second lifting region 298 (shown in broken outline). The second mobile support 292 includes crawler tracks 294 and 296 (shown partially obscured by the slurry apparatus 280). In general, a height of the pontoons 282 and 284 is selected to permit the second mobile support to be positioned to take up the load of the slurry apparatus 280.

In this embodiment, a stability triangle 300 is defined between the lifting region 298 and the pivot 172. The stability triangle 300 has a similar longitudinal extent between the pivot and the second mobile support 292, but has a reduced lateral extent across the slurry apparatus 280. Accordingly, while the support embodiment 290 should permit similar upwardly or downwardly inclined paths to be negotiated safely, a cross slope of the path would need to fall within tighter restrictions so as to avoid a center of mass 302 displacing laterally outside the bounds of the stability triangle 300.

On reaching the new operating location, the actuator 150 of the coupling arm 134, and the hydraulically actuated platform of the second mobile support 292 are operated to lower the slurry apparatus 100 such that the ground engaging pontoons engage the ground in the new location. Advantageously, the transport system 290 shown in FIG. 8 allows the second mobile support 292 to be positioned without having to first unload the slurry apparatus 280 using hydraulic jacks as described above in connection with FIG. 5.

Advantageously, the embodiments described above permit a large apparatus such as the slurry apparatuses 100 and 280 to be relocated under safe and stable conditions, without requiring significant preparation of the ground over which the apparatus is required to move. Furthermore, the support embodiments shown facilitate moving at a greater speed once the load of the slurry apparatus is taken up by the mobile supports. For example, a speed of about 12 meters per minute may be achieved, thereby allowing a 2 kilometer move to be completed in a few hours.

Although specific embodiments of the invention have been described and illustrated, such embodiments should be considered illustrative of the invention only and not as limiting the invention as construed in accordance with the accompanying claims. Various modifications of form, arrangement of components, steps, details and order of operations of the embodiments illustrated, as well as other embodiments of the invention, will be apparent to persons skilled in the art upon reference to this description. It is therefore contemplated that the appended claims will cover such modifications and embodiments as fall within the true scope of the invention. In the specification including the claims, numeric ranges are inclusive of the numbers defining the range. Citation of references herein shall not be construed as an admission that such references are prior art to the present invention.

What is claimed is:

1. A system for transporting a slurry apparatus to a new operating location, the slurry apparatus having a center of mass, the system comprising:
a first mobile support for coupling to a first lifting region of the slurry apparatus, the first mobile support being located adjacent to the slurry apparatus; and
a second mobile support for supporting a second lifting region of the slurry apparatus, the first and second lifting regions being selected such that the center of mass of the slurry apparatus is disposed within a stability region defined between the first lifting region and the second lifting region;
the first and second mobile supports being operable to take up a load of the slurry apparatus and to advance in a desired direction to cause the slurry apparatus to be moved toward the new operating location.

2. The system of claim 1 wherein the first lifting region comprises a lifting region on a first side of the slurry apparatus, the lifting region being centrally located on the first side.

3. The system of claim 1 wherein the slurry apparatus comprises ground engaging supports for supporting the slurry apparatus when the slurry apparatus is in a stationary operating position and wherein the second mobile support is operable to engage the second lifting region of the slurry apparatus.

4. The system of claim 3 wherein the first and second mobile supports are operably configured to transfer support of the slurry apparatus from the ground engaging supports to the first and second mobile supports prior to commencing the advancing of the first and second mobile supports.

5. The system of claim 4 further comprising a plurality of hydraulically actuated supports operably configured to bear the load of the slurry apparatus while transferring support of the slurry apparatus from the ground engaging supports to the first and second mobile supports.

6. The system of claim 4 further comprising:
a coupling arm coupled to the first lifting region and bearing on the first mobile support, the coupling arm being operably configured to take up a load of the first lifting region of the slurry apparatus; and
the second mobile support having a support surface operably configured to be elevated to take up a load of the second lifting region of the slurry apparatus.

7. The system of claim 6 wherein the coupling arm comprises at least two articulated portions having a hydraulic actuator coupled between the at least two portions, the coupling arm being operably configured to cause the load of the first lifting region to be taken up by operating the hydraulic actuator to cause the coupling arm to elevate the first lifting region of the slurry apparatus with respect to the first mobile support.

8. The system of claim 7 wherein the coupling arm is operably configured to be further elevated or lowered while advancing the first and second mobile supports along an inclined ground surface to cause the center of mass to remain spaced inwardly with respect to the defined stability region.

9. The system of claim 4 wherein the slurry apparatus comprises at least two pontoon supports extending along opposite sides of the slurry apparatus for supporting the slurry apparatus when the slurry apparatus is in a stationary operating position.

10. The system of claim 1 wherein the second lifting region comprises a peripherally located lifting region extending generally along a second side of the slurry apparatus opposite to the first side, the first and second lifting regions defining a generally triangular shaped stability region.

11. The system of claim 1 wherein the second lifting region comprises a second lifting region supported on a second mobile support and a third lifting region supported on a third mobile support, the second and third lifting regions being spaced apart along a second side of the slurry apparatus opposite to the first side, the first, second, and third lifting regions defining a generally triangular shaped stability region.

12. The system of claim 11 wherein the second lifting region comprises a first corner region located on the second side of the slurry apparatus and the third lifting region comprises a second corner region located on the second side of the slurry apparatus.

13. The system of claim 1 further comprising a coupling arm mounted on and extending outwardly from the first lifting region of the slurry apparatus for coupling the first mobile support.

14. The system of claim 1 wherein the first and second mobile supports comprise respective crawler tracks operably configured to receive a motive force for advancing the first and second mobile supports.

15. The apparatus of claim 14 wherein the crawler track of the first mobile support comprises first and second spaced apart crawler tracks operably configured to cause a change of direction of at least the first mobile support by providing a differential motive force to the first and second crawler tracks.

16. A method for transporting a slurry apparatus to a new operating location, the slurry apparatus having a center of mass, the method comprising:
coupling a first lifting region of the slurry apparatus to a first mobile support located adjacent to the slurry apparatus;
supporting a second lifting region of the slurry apparatus on a second mobile support, the first and second lifting regions being selected such that the center of mass of the slurry apparatus is disposed within a stability region defined between the first lifting region and the second lifting region; and
taking up a load of the slurry apparatus and advancing the first and second mobile supports in a desired direction to cause the slurry apparatus to be moved toward the new operating location.

17. The method of claim 16 wherein coupling the first lifting region to the first mobile support comprises coupling a lifting region on a first side of the slurry apparatus to the mobile support, the lifting region being centrally located on the first side.

18. The method of claim 16 wherein the slurry apparatus comprises ground engaging supports for supporting the slurry apparatus when the slurry apparatus is in a stationary operating position and wherein supporting the second lifting region comprises causing the second mobile support to engage the second lifting region of the slurry apparatus.

19. The method of claim 18 further comprising transferring support of the slurry apparatus from the ground engaging supports to the first and second mobile supports prior to commencing the advancing of the first and second mobile supports.

20. The method of claim 19 wherein transferring support of the slurry apparatus from the ground engaging supports comprises causing a plurality of hydraulically actuated supports to bear the load of the slurry apparatus while transferring support of the slurry apparatus from the ground engaging supports to the first and second mobile supports.

21. The method of claim 19 wherein transferring support of the slurry apparatus from the ground engaging supports comprises:
causing a load of the first lifting region of the slurry apparatus to be taken up by a coupling arm coupled to the first lifting region and bearing on the first mobile support; and
elevating a support surface of the second mobile support to take up a load of the second lifting region of the slurry apparatus.

22. The method of claim 21 wherein the coupling arm comprises at least two articulated portions having a hydraulic actuator coupled between the at least two portions, and wherein causing the load of the first lifting region to be taken up by the coupling arm comprises operating the hydraulic actuator to cause the coupling arm to elevate the first lifting region of the slurry apparatus with respect to the first mobile support.

23. The method of claim 22 further comprising causing the coupling arm to be further elevated or lowered while advancing the first and second mobile supports along an inclined ground surface to cause the center of mass to remain spaced inwardly with respect to the defined stability region.

24. The method of claim 19 wherein transferring support of the slurry apparatus from the ground engaging supports comprises transferring support from at least two pontoon supports extending along opposite sides of the slurry apparatus.

25. The method of claim 19 further comprising transferring support of the slurry apparatus from the first and second mobile supports to the ground engaging supports on reaching the new operating location.

26. The method of claim 16 wherein supporting the second lifting region on the second mobile support comprises supporting a peripherally located lifting region extending generally along a second side of the slurry apparatus opposite to the first side, the first and second lifting regions defining a generally triangular shaped stability region.

27. The method of claim 16 wherein supporting the second lifting region on the second mobile support comprises supporting a second lifting region on a second mobile support and a third lifting region on a third mobile support, the second and third lifting regions being spaced apart along a second side of the slurry apparatus opposite to the first side, the first, second, and third lifting regions defining a generally triangular shaped stability region.

28. The method of claim 27 wherein supporting the second lifting region comprises supporting a first corner region located on the second side of the slurry apparatus and wherein supporting the third lifting region comprises supporting a second corner region located on the second side of the slurry apparatus.

29. The method of claim 16 wherein coupling the first mobile support comprises coupling the first mobile support to a coupling arm mounted on and extending outwardly from the first lifting region of the slurry apparatus.

30. The method of claim 16 wherein advancing the first and second mobile supports comprises providing a motive force to respective crawler tracks of the first and second mobile supports.

31. The method of claim 30 wherein the crawler track of the first mobile support comprises first and second spaced apart crawler tracks and further comprising causing a change of the direction of at least the first mobile support by providing a differential motive force to the first and second crawler tracks.
